(19) United States
(12) Patent Application Publication
(10) Pub. No.: US 2008/0294638 A1
(43) Pub. Date: Nov. 27, 2008

(54) METHOD AND SYSTEM FOR PARSING CONTENTS OF MEMORY DEVICE

(75) Inventor: YI HUNG KO, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: VIA TECHNOLOGIES, INC., TAIPEI (TW)

(21) Appl. No.: 12/126,961

(22) Filed: May 26, 2008

(30) Foreign Application Priority Data
May 24, 2007 (TW) 096118541

(51) Int. Cl. G06F 7/00

(52) U.S. Cl. 707/6

(57) ABSTRACT

A system and a method for parsing and/or modifying content information of a memory device are provided. A definition file including at least one memory address and at least one associated parameter is provided, wherein each of the parameters corresponds to an event description. The memory address is loaded by a user and content information is fetched from the memory device according to the memory address. The content information is compared with the parameter to find a match. Accordingly, an event description corresponding to the match can be automatically acquired and displayed.

### FIELD OF THE INVENTION

The present invention relates to a method and a system for parsing contents of a memory device, and more particularly to a method and a system for parsing contents of a memory device to acquire and/or modify event descriptions.

### BACKGROUND OF THE INVENTION

A memory device is essential to a computer system, and thus the development of memory devices plays an important role on enhancing the performance of computer systems. Generally speaking, the execution speed of a memory device is higher than other types of storage devices such as a hard disk. When a computer system is executing a program, the program to be executed is stored in the memory device, thereby accelerating the responding speed of the computer system as well as promoting the performance of the computer system.

Since programs for a computer system needs to be stored in memory devices for execution, the programmer needs to know the contents of the memory device in order to realize how the program is executed in the memory device and does necessary debugging. For a programmer that is new and unfamiliar to a certain program designed by other programmers, a supplementary file created by former designers, for example a text file, is needed in order to understand the development of the program. Then the new programmer may run dedicated software for accessing contents of a memory device. The text file can be, for example, a Microsoft® Word file. The programmer then manually switches and checks the contents of the text file and the contents of the memory device to get information of what is happening inside the memory device. It is apparently a troublesome and inefficient process. Furthermore, since at least two software systems need to be executed at the same time, the debugging procedure consumes much more resource of the computer system under this circumstance.

### SUMMARY OF THE INVENTION

Therefore, the present invention provides a system and a method which automatically parse content information of the memory device to acquire corresponding event descriptions. In addition, the event description can be changed by modifying the content information of the memory device. Therefore, lots of laboring and resource can be saved, and the working efficiency can be enhanced.

The present invention provides a method for parsing contents of a memory device, which includes steps of providing a definition file which defines at least one memory address and one or more associated parameters, wherein each of the parameters corresponds to an event description; loading the memory address and fetching a content information from a memory device according to the memory address; comparing the content information with the one or more parameters to find a match of the content information and the parameter; and automatically acquiring and displaying an event description corresponding to the match of the content information and the parameter.

The present invention provides a system for parsing contents of a memory device, which includes: a file storage zone for storing a definition file which defines at least one memory address and one or more associated parameters, wherein each of the parameters corresponds to an event description; a fetch unit for loading the memory address and fetching content information from a memory device according to the memory address; a parsing unit for comparing the content information with the parameter to automatically acquire a current event description corresponding to a match of the content information and the parameter; and a display unit for displaying the current event description.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a flowchart schematically illustrating a method for parsing contents of a memory device according to an embodiment of the present invention;

FIGS. 2A˜2D are exemplified diagrams showing a series of windows displayed through a system interface when parsing contents of a memory device according to an embodiment of the present invention;

FIGS. 2E˜2G are exemplified diagrams showing a series of windows displayed through a system interface when modifying contents of a memory device according to an embodiment of the present invention; and

FIG. 3 is a functional block diagram illustrating a system for parsing contents of a memory device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

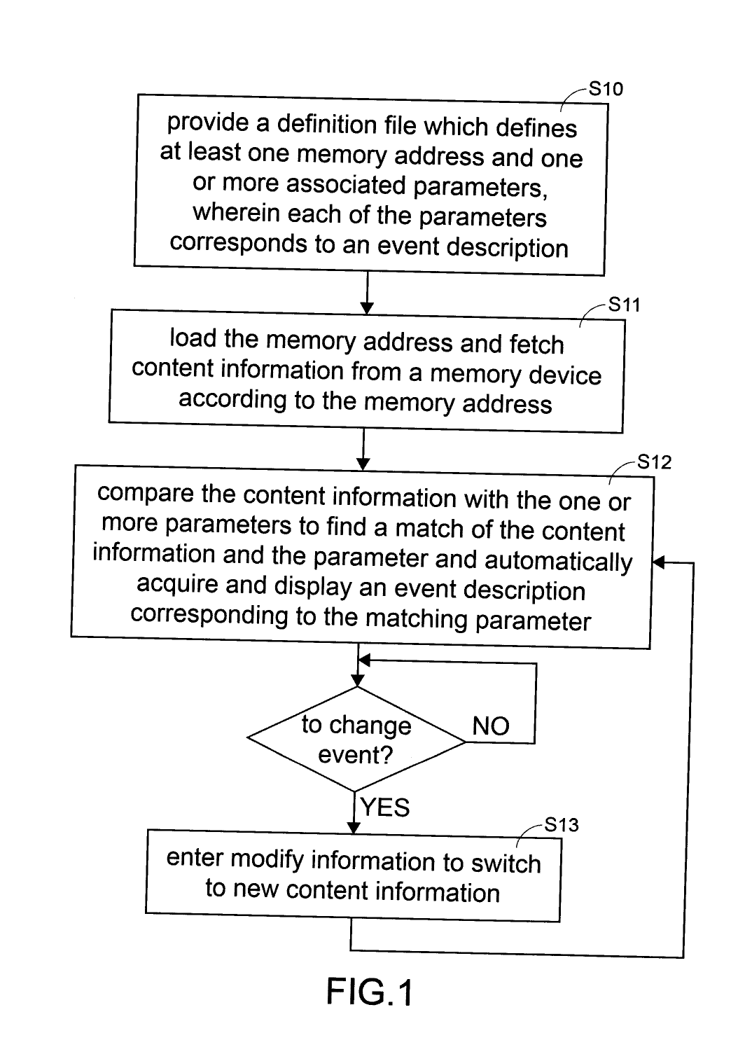

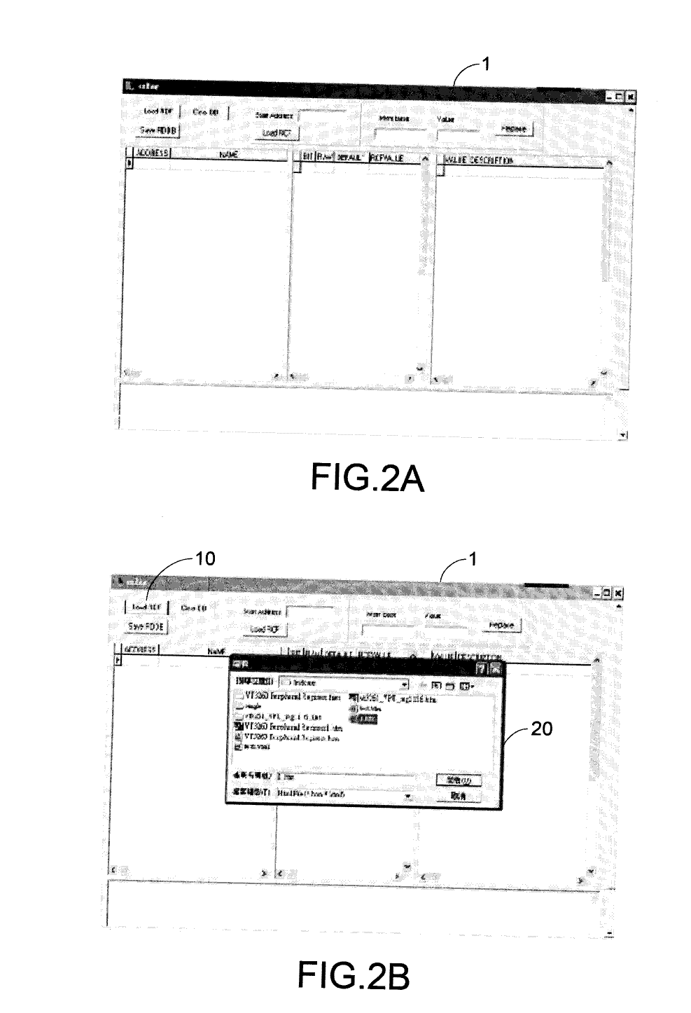

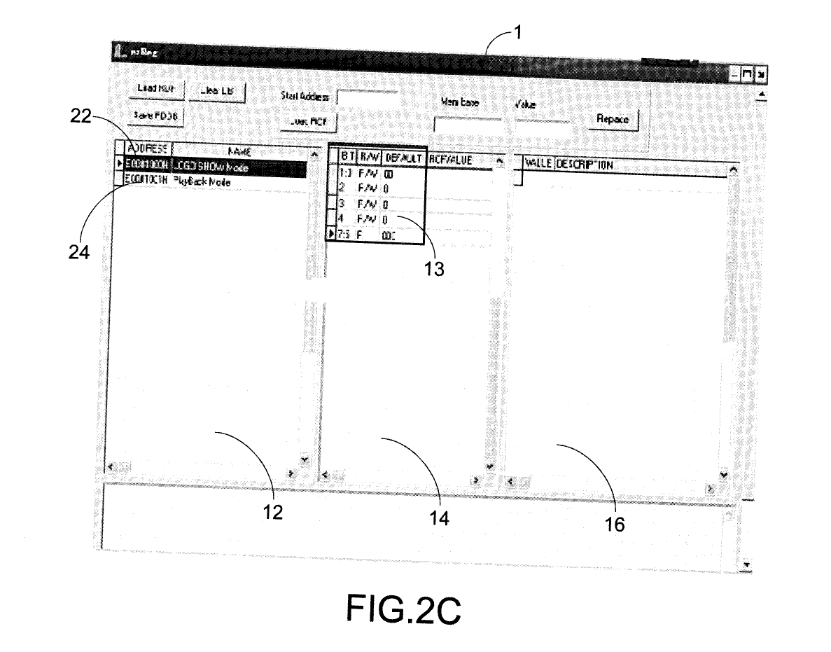

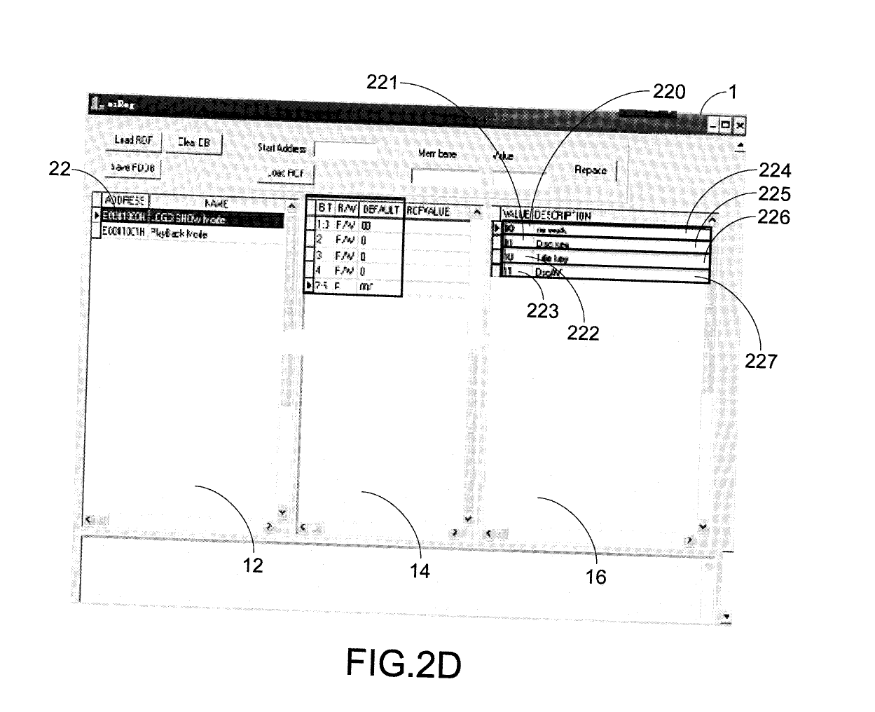

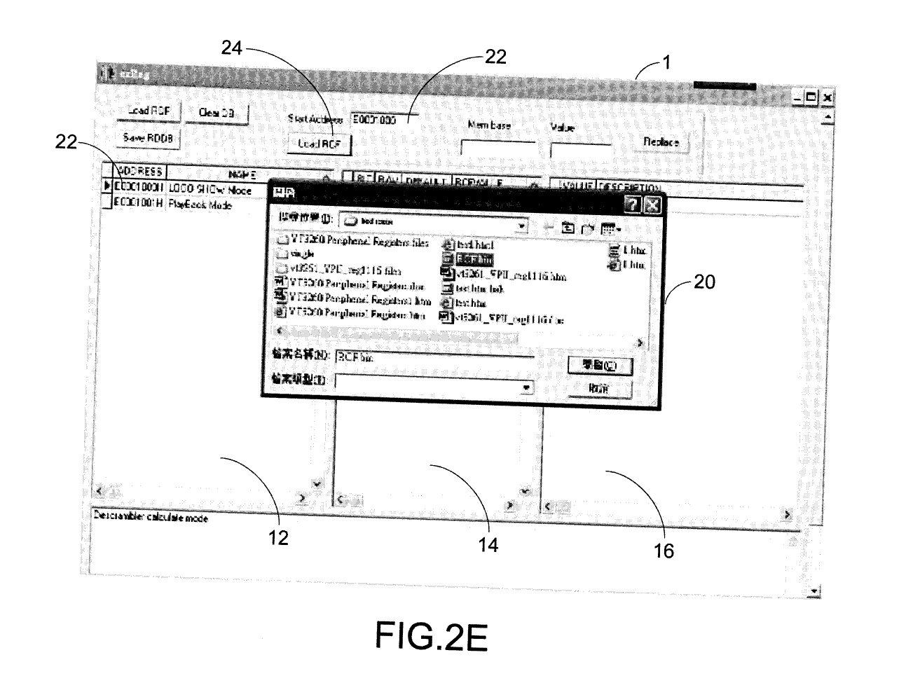

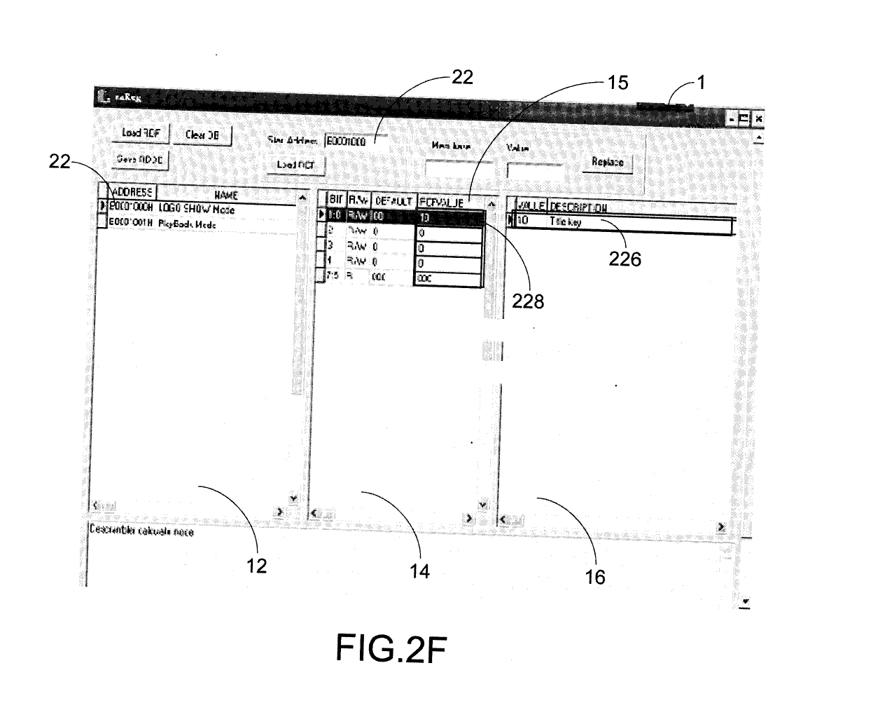

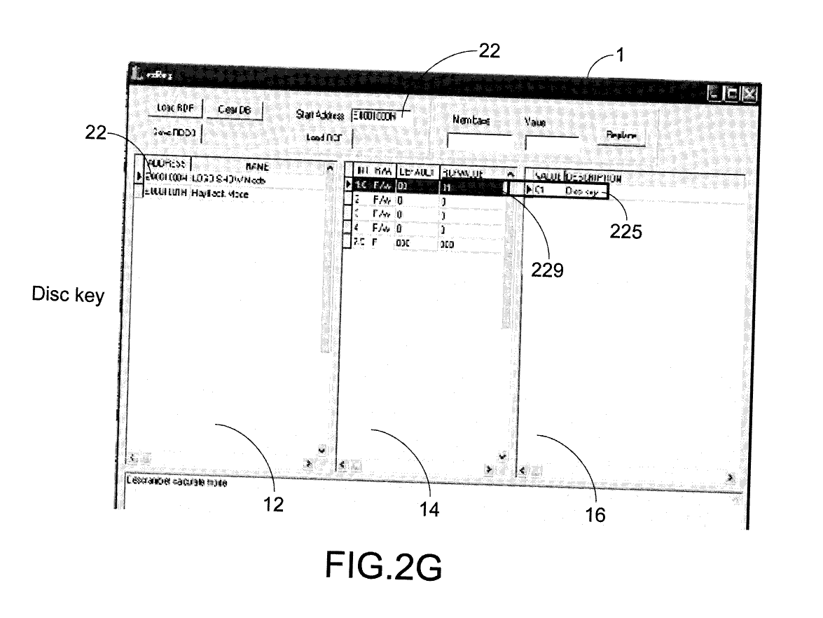

Please refer to FIG. 1 which illustrates a flowchart of parsing content information of a memory device according to an embodiment of the present invention. In Step S10, a definition file is provided. The definition file defines at least one memory address and one or more associated parameters. Each of the parameters corresponds to a related event description. An embodiment of this step is given as follows for further understanding with reference to a series of windows displayed through a system interface, as shown in FIGS. 2A-2D. The system interface 1 includes a first load button 10 (FIG. 2B) which can be triggered by the user to load a definition file displayed in a file window. The definition file comprises a memory address 22, e.g. E0001000H, and another memory address 24, e.g. E0001001H, which are displayed in a first display zone 12 as depicted in FIG. 2C. In this embodiment, the memory address 22 indicates the audio/video display mode, for example, a logo show mode. In this audio/video display mode, the memory address 22 includes a 8-bit data. The 8-bit data is displayed in a default column 13 in a second display zone 14. The bit length can be changed according to actual requirement of control in response to each operation. An even description corresponding to each mode of the memory address 22 is obtained in a third display zone 16. In more detail, if bit (0,1) of the memory address 22 represents a descrambler calculation mode in the second display zone 14, the bit (0,1) can be set as 4 different parameters 220˜223: 00, 01, 10, 11, as shown in FIG. 2D. The four parameters 220˜223 correspond to 4 different related event descriptions 224˜227. For example, the parameter values 00, 01, 10 and 11 correspond to no decoding (no work), decoding video data (disk key), decoding title information (title key) and decoding audio data (Drc Av), respectively.

Then Step S11 is executed to load the memory address 22, thereby acquiring one or more content information corresponding to the memory address 22 from a physical memory. Take the memory address “E0001000H” as an example and refer to FIGS. 2E and 2F in which further more windows are displayed through the system interface 1. The system interface 1 includes a second load button 24 for the user to load a file associated with the memory address 22 in the file window 20 and, thereby acquiring 8-bit content information 228 corresponding to the memory address 22 from the physical memory. The content information 228 is shown in a physical-memory RCFVALUE column 15 in the second display zone 14 (FIG. 2E).

In subsequent Step S12, the content information 228 is compared with the parameters to map the content information 228 to related parameter and the corresponding event description is further displayed. For example, as shown in FIG. 2D, the content information 228 of bit (0,1) of the physical memory column RCFVALUE 15 is compared with the 4 parameters of bit (0,1) of the default column 13. If the parameter value “10” is shown in the third display zone 16 (FIG. 2F), it indicates that the “title key” event 226 is being executed in the physical memory. Accordingly, by automatically parsing contents of the memory device, the event description corresponding to specified content information can be acquired in an efficient manner.

Furthermore, the change of events can be achieved by simply entering a modify information to switch to new content information (S13). For example, if the user changes the content information 228 from “10” to “01” (see content information 229 in the RCFVALUE 15 in FIG. 2G), the “disc key” event 225 will replace for the “title key” event 226 and is timely shown in the third display zone 16. Then the new content information 229 will be written into the physical memory to execute the “disc key” operation. Accordingly, the present invention can directly perform comparison and modification of memory contents without activating two different software programs. Thus the resource of the computer system will not be unduly occupied.

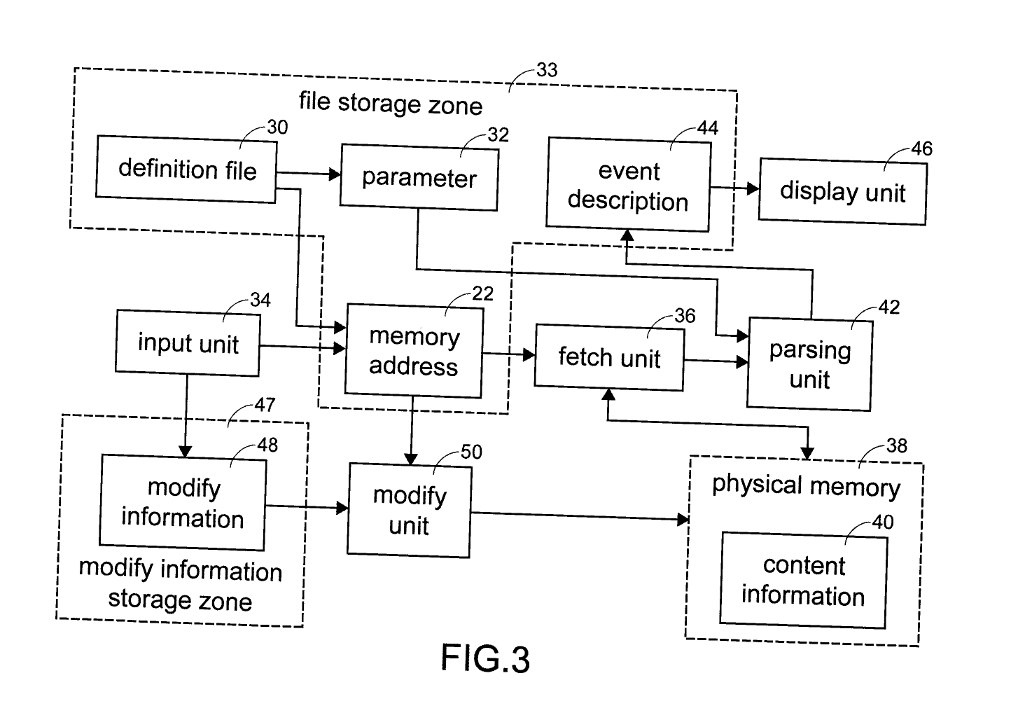

Please refer to FIG. 3 which is a block diagram schematically illustrating a system for parsing contents of a memory device according to an embodiment of the present invention. The system includes a file storage zone 33, an input unit 34, a fetch unit 36, a parsing unit 42 and a display unit 46. The file storage zone 33 stores therein a definition file 30 which defines at least one memory address 22 and associated one or more parameters 32. Each of the parameters corresponds to a related event description 44. The fetch unit 36 receives the memory address inputted by the user via the input unit 34 and fetches one or more content information 40 corresponding to the memory address 22 from a physical memory 38. The parsing unit 42 compares the content information 40 with the one or more parameter 32 for a match and thus obtain the corresponding context description 44 related to the context information 40 of the parameter 32. Then the event description 44 is shown by the display unit 46 to notify the user.

In addition, if the user intends to modify the content information 40 corresponding to the memory address 22, the modify information can be inputted from the input unit 34 and sent to a modify unit 50. The modify unit 50 then modifies the content information 40 in the physical memory 38 according to the memory address 22. The system further includes a modify information storage zone 47 for storing the modify information 48. When the user intends to use certain modify information 48, the stored modify information 48 can be quickly loaded, thereby improving the operational efficiency.

To sum up, the present invention provides a system and a method for parsing contents of a memory device so as to easily acquire and modify the event descriptions of the memory contents. In this way, the laboring and resource waste can be minimized, and the operational efficiency can be improved.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for parsing contents of a memory device, comprising steps of:
providing a definition file comprising at least one memory address and at least one associated parameter, wherein each of the parameters corresponds to an event description;
loading the memory address and fetching content information from a memory device according to the memory address;
comparing the content information with the parameter to find a match of the content information and the parameter; and
automatically acquiring and displaying an event description corresponding to the match of the content information and the parameter on a display device.

2. The method according to claim 1, further comprising a combination of the following steps:
modifying the content information of the memory address to new content information according to modify information inputted by a user and storing the modify information;
comparing the new content information with the parameters to find a new match; and
automatically updating and displaying a new event description according to the new match.

3. The method according to claim 1, further comprising:
inputting modify information corresponding to the memory address by a user.

4. The method according to claim 3, further comprising:
loading the modify information and modifying the content information corresponding to the memory address according to the modify information.

5. The method according to claim 3, further comprising:
storing the modify information in a modify information storage zone.

6. A system for parsing contents of a memory device, comprising:
a file storage zone for storing a definition file comprising at least one memory address and at least one associated parameters, wherein each of the parameters corresponds to an event description;
a fetch unit for loading the memory address and fetching content information from a memory device according to the memory address;
a parsing unit for comparing the content information with the parameter to automatically acquire a current event description corresponding to a match of the content information and the parameters; and
a display unit for displaying the current event description.

7. The system according to claim 6, further comprising an input unit for inputting the memory address by a user.

8. The system according to claim 6, further comprising:
an input unit for entering modify information by a user;
an additional storage zone for storing the modify information; and
a modify unit for modifying the content information corresponding to the memory address to new content information according to the modify information.

9. The system according to claim 8, wherein the parsing unit compares the new content information with the associated parameters to automatically acquire an updated event description corresponding to a new match of the new content information and the parameters, and the display unit shows the updated event description.

10. The system according to claim 6, wherein the memory address, the content information and the current even description are displayed by the display unit in one or more windows of a system interface and can be modified by a user via the system interface.
